(19) United States
(12) Patent Application Publication
(10) Pub. No.: US 2014/0337799 A1
(43) Pub. Date: Nov. 13, 2014

(54) METHOD, APPARATUS AND TERMINAL FOR SELECTING CONTENT

(71) Applicant: Tencent Technology (Shenzhen) Company Limited, Shenzhen (CN)

(72) Inventors: Qinghua ZHONG, Shenzhen (CN); Guang YANG, Shenzhen (CN); Chao HU, Shenzhen (CN); Yinglei LIANG, Shenzhen (CN); Wei YAN, Shenzhen (CN); Lei LI, Shenzhen (CN); Hao NIAN, Shenzhen (CN)

(73) Assignee: TENCENT TECHNOLOGY (SHENZHEN) COMPANY LIMITED, Shenzhen (CN)

(21) Appl. No.: 14/262,445

(22) Filed: Apr. 25, 2014

Related U.S. Application Data
(63) Continuation of application No. PCT/CN2014/070258, filed on Jan. 7, 2014.

(30) Foreign Application Priority Data
May 7, 2013 (CN) 201310163803.4

(51) Int. Cl. G06F 3/0484; G06F 3/0482

(52) U.S. Cl. CPC G06F 3/04847; G06F 3/0482; G06F 3/04842
USPC 715/833

(57) ABSTRACT

A method, an apparatus, and a terminal for selecting content. The method includes displaying a rail and a slider on the rail in a predetermined region of a display screen, the rail including at least one rail segment and each rail segment corresponding to one list content; receiving a first sliding signal for controlling the slider; and sliding the slider on the rail based on the first sliding signal and performing selection operation or selection-clearing operation on the list content corresponding to the rail segments through which the slider passes during its sliding. With the configurations of the present disclosure, a plurality of list contents are selected in batch or such selection is cleared in batch by sliding the slider only once or by sliding a few times.

### CROSS-REFERENCE TO RELATED APPLICATIONS

This application is a continuation application of PCT Patent Application No. PCT/CN2014/070258, entitled “METHOD, APPARATUS AND TERMINAL FOR SELECTING CONTENT,” filed on Jan. 7, 2014, which claims priority benefit of Chinese Patent Application No. 201310163803.4, entitled “METHOD, APPARATUS AND TERMINAL FOR SELECTING CONTENT,” filed on May 7, 2013, the disclosures of which are herein incorporated by reference in their entireties.

### TECHNICAL FIELD

The present disclosure relates to the field of touch control, in particular to a method for selecting content, an apparatus for selecting content, and a terminal using the same.

### BACKGROUND

Information such as a short message, an instant messenger chat and an email is often presented on a terminal in a manner of list display, such that, on the screen of the terminal, the items of information are displayed sequentially one by one from the top to the bottom, each list content often corresponds to an item of information and the sources or timings of respective items of information are different from each other.

Usually, the user needs to select or check the list content to cancel, forward or unload the information or change the state of the information.

FIG. 1 is a schematic diagram that shows an existing method for selecting content.

As shown in FIG. 1, in a present method for selecting content, a check box on the left of each of list content may be displayed. When a user wants to select a list content 12, he/she can click a check box 14 on the left of the list content 12. If the check box 14 changes from white to black, the list content 12 is selected. If the user wants to clear the selection of a list content 16, he/she can click a check box 18 on the left of the list content 16. If the check box 18 changes from black to white, the selection of the list content 16 is cleared.

When a user wants to select a plurality of list contents to cancel, forward, unload the selected information in batch or change the state of the information in batch, the user needs to click the plurality of list contents one by one to select them. For example, if one hundred list contents are to be selected, the user must click one hundred times to select the one hundred list contents even if the user's operations are totally correct. If the operations of sliding the list contents are further counted, more than 130 times of actions may be taken by the user to select all the list contents. Therefore, the efficiency of the whole contents selection procedure is very low. At the same time, the contents selection procedure takes its toll on the terminal, rapidly reducing the key life, the touch screen life, and the battery life.

### SUMMARY

The present disclosure provides a method, an apparatus and a terminal for selecting contents. The technical solutions are as follows.

According to an aspect of the present disclosure, a method for selecting content comprises displaying a rail and a slider on the rail in a predetermined region, the rail having at least one rail segment and each of the at least one rail segments corresponding to one list content; receiving a first sliding signal for controlling the slider; and sliding the slider on the rail based on the first sliding signal and performing selection operation or selection-clearing operation on the list content corresponding to the at least one rail segment through which the slider passes during its sliding.

According to another aspect of the present disclosure, an apparatus for selecting content comprises a slider displaying module using a processor and configured to display a rail and a slider on the rail in a predetermined region, the rail having at least one rail segment and each of the at least one rail segments corresponding to one list content; a first receiving module using a processor and configured to receive a first sliding signal for controlling the slider; and a content selecting module using a processor and configured to slide the slider on the rail based on the first sliding signal and perform selection operation or selection-clearing operation on the list content corresponding to the at least one rail segment through which the slider passes during its sliding.

According to a still aspect of the present disclosure, a terminal includes an apparatus for selecting content mentioned above.

According to a still aspect of the present disclosure, a non-transitory computer-readable storage medium comprises a set of instructions for directing at least one processor to perform acts of the method for selecting content mentioned above.

### BRIEF DESCRIPTION OF THE DRAWINGS

In order to describe the embodiments of the present disclosure more clearly, a brief description of the drawings, which are referred to in describing the present disclosure is set out below. The drawings described below are only some embodiments of the disclosure and other drawings can be conceived, based on the described drawings, by a person skilled in the art without any inventive effort.

FIG. 1 is a schematic diagram that shows an existing method for selecting content.

FIG. 2 is a flow chart of a method for selecting content according to a first embodiment of the present disclosure.

FIG. 3A is a flow chart of a method for selecting content according to a second embodiment of the present disclosure.

FIGS. 3B-3E are operation schematic diagrams that show the procedures for selecting content according to the second embodiment of the present disclosure.

FIG. 4A is a flow chart of a method for selecting content according to a third embodiment of the present disclosure.

FIGS. 4B-4F are operation schematic diagrams that show the procedures for selecting content according to the third embodiment of the present disclosure.

FIG. 5A is a flow chart of a method for selecting content according to a fourth embodiment of the present disclosure.

FIGS. 5B-5G are operation schematic diagrams that show the procedures for selecting content according to the fourth embodiment of the present disclosure.

FIG. 6 is a structural block diagram that shows an apparatus for selecting content according to a fifth embodiment of the present disclosure.

FIG. 7 is a structural block diagram that shows an apparatus for selecting content according to a sixth embodiment of the present disclosure.

FIG. 8 is a structural block diagram that shows an apparatus for selecting content according to a seventh embodiment of the present disclosure.

FIG. 9 is a structural block diagram that shows an apparatus for selecting content according to an eighth embodiment of the present disclosure.

FIG. 10 is a structural schematic diagram that shows a terminal according to a ninth embodiment of the present disclosure.

### DETAILED DESCRIPTION

In order to make the technical solution and advantages of the disclosure more apparent, a more detailed description of the disclosure is given below in conjunction with the embodiments and the accompanying drawings.

The “terminal” mentioned in the context may be a smart cell phone, tablet computer, electronic book reader, MP3 player, MP4 player, portable laptop computer, and so on.

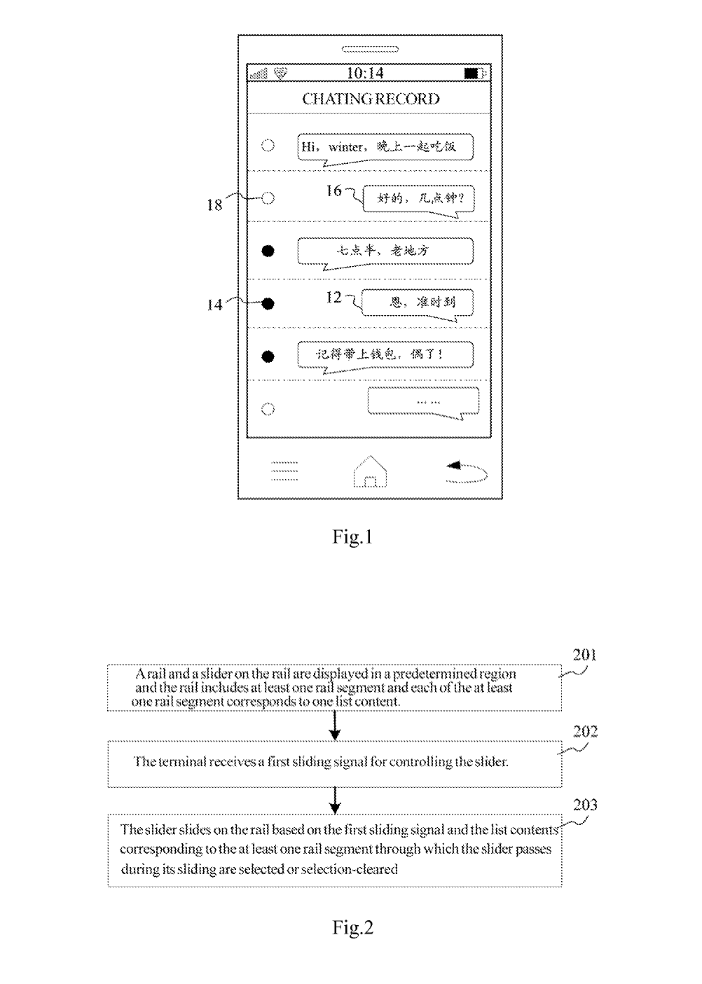

FIG. 2 is a flow chart of a method for selecting content according to a first embodiment of the present disclosure.

Referring to FIG. 2, it shows a flow chart of a method for selecting content according to a first embodiment of the present disclosure. The method can be implemented in a terminal and includes the following steps.

At step S201, a rail and a slider on the rail are displayed in a predetermined region and the rail includes at least one rail segment and each of the at least one rail segments corresponds to one list content. At step S202, the terminal receives a first sliding signal for controlling the slider. At step S203, the slider slides on the rail based on the first sliding signal and the list contents corresponding to the at least one rail segment through which the slider passes during its sliding are selected or selection-cleared.

The method for selecting content according to the present disclosure solves the problems of the low efficiency of the existing content selection procedure and causing the key life, the touch screen life and the battery life to drop rapidly by sliding the slider on at least one rail segment of the rail so as to check or uncheck the list contents corresponding to the at least one rail segment through which the slider passes during its sliding. Further, the method for selecting content according to the present disclosure can select a plurality of list contents in batch or clear such selections in batch by sliding the slider only once or by sliding it a few times.

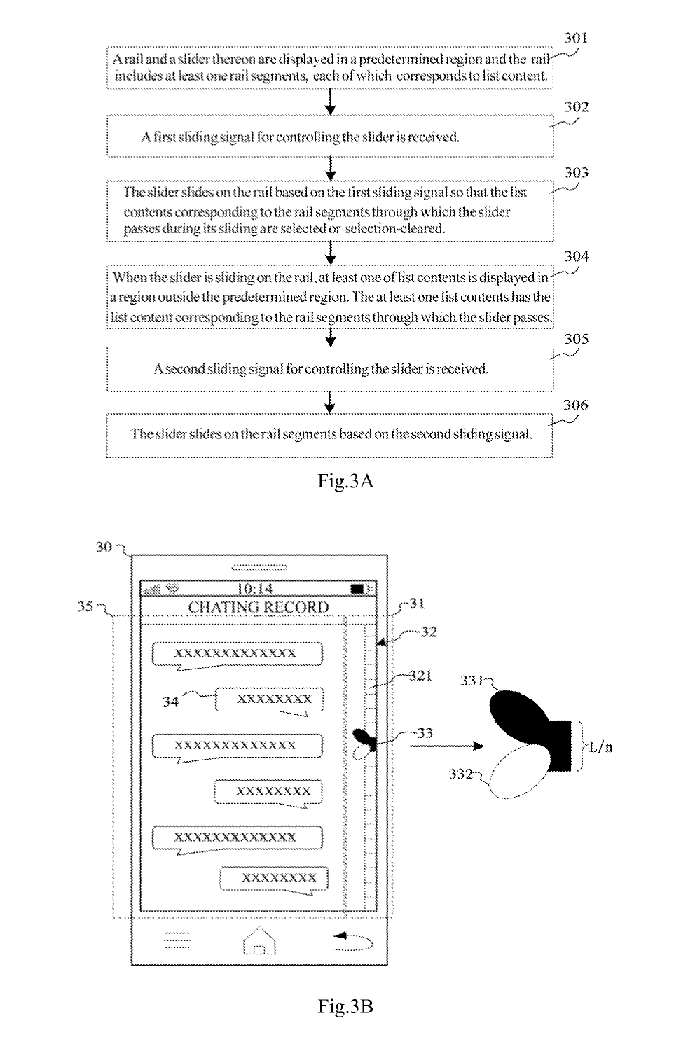

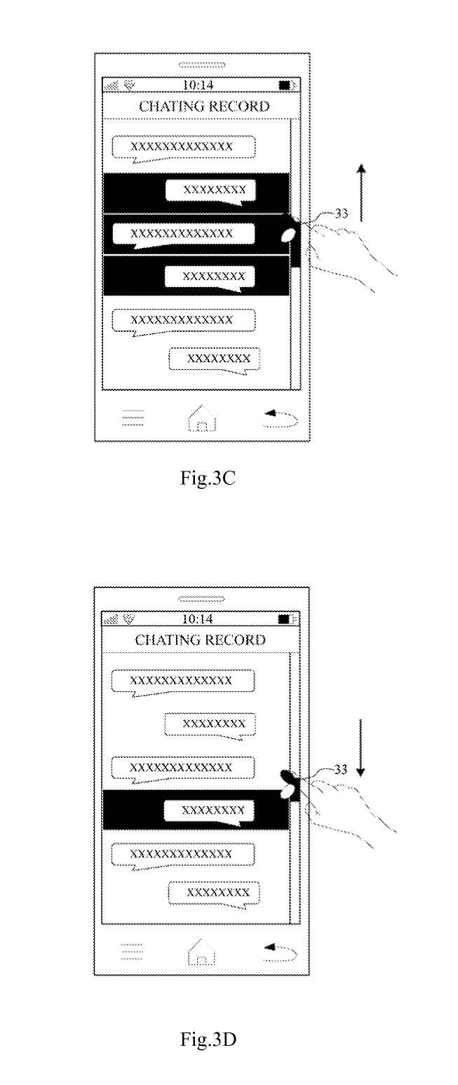

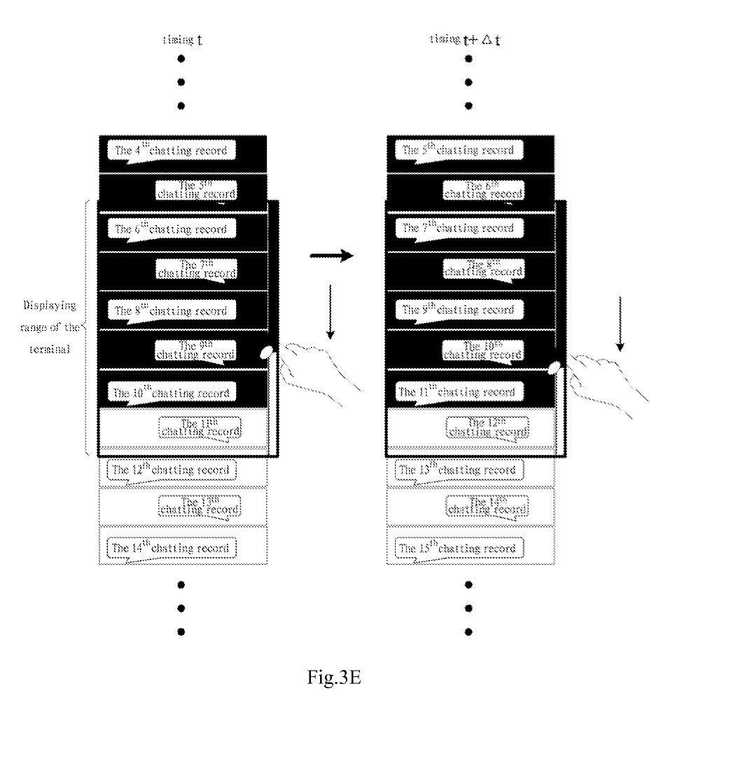

FIG. 3A is a flow chart of a method for selecting content according to a second embodiment of the present disclosure. FIGS. 3B-3E are operation schematic diagrams that show the procedures for selecting content according to the second embodiment of the present disclosure.

As shown in FIG. 3A and FIG. 3B, it is a flow chart of a method for selecting content according to a second embodiment of the present disclosure. The embodiment is illustrated by implementing the method for selecting content in a terminal As a preferred embodiment, which is provided based on the first embodiment as shown in FIG. 2, the method includes the following steps.

At step S301, a rail and a slider on the rail are displayed in a predetermined region of a display screen of a terminal 30, and the rail includes at least one rail segment and each of the at least one rail segments corresponds to one list content.

As shown in FIG. 3B, a terminal 30 has a user interface displayed on its screen. The user interface includes a predetermined region 31, and a rail 32 and a slider 33 on the rail displayed in the predetermined region 31. As shown, the predetermined region 31 is illustrated as the right region of the terminal 30.

The rail 32 includes at least one rail segment 321 and the number of the at least one rail segments 321 is equal to the number of the list contents 34. For example, if the number of the list contents 34 is 20, the number of the at least one rail segment 321 is 20. A borderline (i.e. the transverse dot line as shown in the figure) between two adjacent rail segments 321 may or may not be displayed. The rail segments 321 correspond to the list contents 34 one by one, that is, in the order from the top to the bottom, the first rail segment 321 corresponds to the first list content 34, the second rail segment 321 corresponds to the second list content 34, and so on. In addition, since the length of the rail 32 is equal to that of the screen, the length of the rail segments 321 may be determined based on the total number of the list contents 34. If the length of each of the rail segments 321 is the same, the length of each of the rail segments 321 is L/n, “n” indicating the number of the list contents 34.

A plurality of list contents 34 may be displayed in a left region 35 at the left of the predetermined region 31. The plurality of list contents displayed in the left region 35 may be all of the list contents or part of the list contents. The list content(s) after the currently displayed list contents can be viewed by scrolling up the left region 35, and the list content(s) before the currently displayed list contents can be viewed by scrolling down the left region 35. The scrolling operation in the left region 35 does not affect the display content in the predetermined region 31.

The height of the slider 33 may be equal to the length of one rail segment 321. The slider 33 has a first portion 331 and a second portion 332. The first portion 331 is configured to receive a first sliding signal and the second portion 332 is configured to receive a second sliding signal.

At the step S302, the first sliding signal for controlling the slider is received. Specifically, the terminal receives a dragging signal applied to the first portion 331 and uses the dragging signal as the first sliding signal.

The dragging signal is a signal based on which the slider 33 is dragged up or down in a sliding direction of the rail.

At the step S303, the slider slides on the rail based on the first sliding signal so that the list contents corresponding to the rail segments through which the slider passes during its sliding are selected or selection-cleared. After receiving the first sliding signal, the terminal causes the slider to slide on the rail based on the first sliding signal. When the slider slides on the rail, it can pass through at least one rail segment.

Specifically, on the one hand, during the step 303, if the list content corresponding to the rail segments through which the slider passes is in an unchecked state, the unchecked state of the list content is switched into a checked state.

As shown in FIG. 3C, it is assumed that initially all the list contents are in an unchecked state. At this time, the three list contents corresponding to the three rail segments through which the slider passes in sliding up may be selected, that is, the unchecked state of the three list contents is switched into the checked state. For example, the background color of the three list contents and the corresponding three rail segments may be different from that of other list contents and the rail segments.

On the other hand, if the list contents corresponding to the rail segments through which the slider passes are in a checked state, the checked state of the list contents is switched into an unchecked state.

As shown in FIG. 3D, it is assumed that the slider is sliding down after the three list contents have been selected. The two list contents corresponding to the two rail segments through which the slider passes in sliding down may be selection-cleared, that is, the checked state of the two list contents is switched to the unchecked state.

At the step S304, when the slider is sliding on the rail, at least one of the list contents is displayed in a region outside the predetermined region. The at least one list content has the list content corresponding to the rail segments through which the slider passes during its sliding.

In general, the sliding of the list contents displayed in the left region 35 is independent from that of the right slider 33. However, the sliding of the left region 35 and the right slider 33 can be associated with each other. In other words, when list contents corresponding to the rail segments through which the slider 33 is passing in its sliding are not in the left region 35, the list contents in the left region 35 may be displayed in scrolling so that at least one of the list contents displayed in the left region 35 has the list content corresponding to the rail segments through which the slider passes during its sliding.

As shown in FIG. 3E, it is assumed that the slider is sliding down. At timing t, the list content “the tenth chat record” corresponding to the rail segments through which the slider is passing is the second last one of the list contents displayed in the left region. At timing t+A, the list content “the eleventh chat record” corresponding to the rail segments through which the slider is passing is scrolled to the position in which the list content “the tenth chat record” was at timing t, and the list content “the twelfth chat record” after list content “the eleventh chat record” is scrolled and displayed as the last list content. With this scrolling display, the list contents corresponding to the rail segments through which the slider is passing in its sliding can be displayed in the left region all the times. In the present embodiment, when the slider slides down, it is exemplified that the list content corresponding to the rail segments through which the slider is passing is the second last list content. In other embodiments, the list content corresponding to the rail segments through which the slider is passing may be the first list content, the second list content, the middle list content, the last list content and so on, which is not limited in the description.

At step S305, a second sliding signal for controlling the slider is received. There is a case that, in selecting list contents or clearing such selections, the position of the slider 33 needs to be adjusted probably. At this time, the slider 33 needs only to be moved on the rail 32 without performing the selection or selection-clearing on the list contents. For this reason, a second sliding signal for controlling the slider is also received.

Specifically, the terminal receives a dragging signal applied to the second portion 332 and uses the dragging signal as the second sliding signal. The dragging signal may be a signal which causes the slider 33 to be dragged up or down in a sliding direction of the rail.

At the step S306, the slider slides on the rail segments based on the second sliding signal. After receiving the second sliding signal, the terminal causes the slider 33 to slide on the rail based on the second sliding signal. When the slider slides on the rail, it may pass through the at least one rail segment but one or more list contents will not be selected or selection-cleared.

A user may perform any combination based on a different sequence of the first sliding signal and the second sliding signal to freely determine to select one or more portions of all the list contents. Each portion of list contents may include one of the list contents or several adjacent successive list contents. If the user wants to select several successive list contents, the whole operation procedure includes only two steps “triggering the first sliding signal” and “dragging in the corresponding rail segments”.

The method for selecting content according to the present disclosure solves the problems of the low efficiency of the existing contents selecting procedure and the rapid drop in the key life, the touch screen life and the battery life by sliding the slider on at least one rail segment to check or uncheck the list contents corresponding to the rail segments through which the slider passes during its sliding. Further, the method for selecting content according to the present disclosure can select a plurality of list contents in batch or clear such selections in batch by sliding the slider only once or by sliding it a few times. In particular, when many list contents are to be selected at one time, the number of operations saved by the method of the present embodiment will be significant.

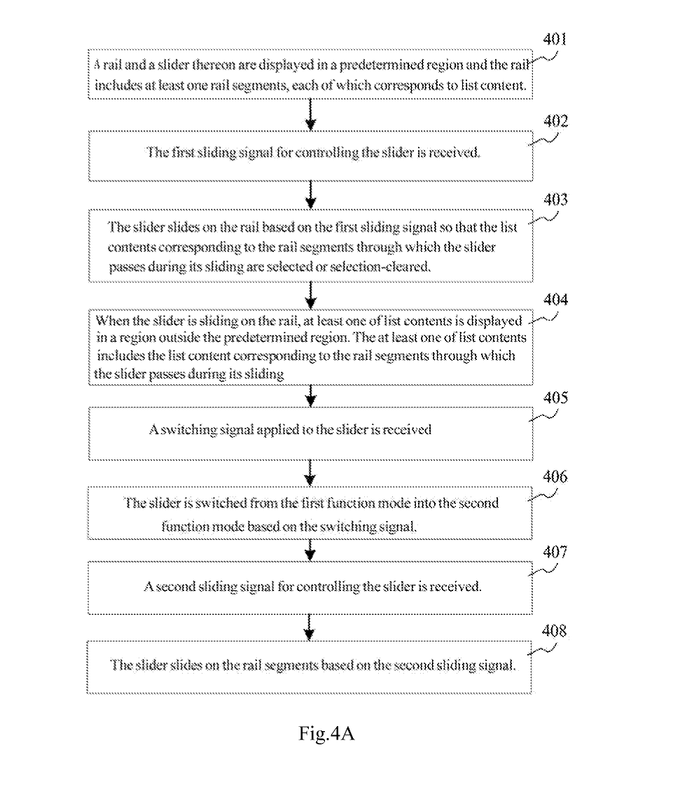

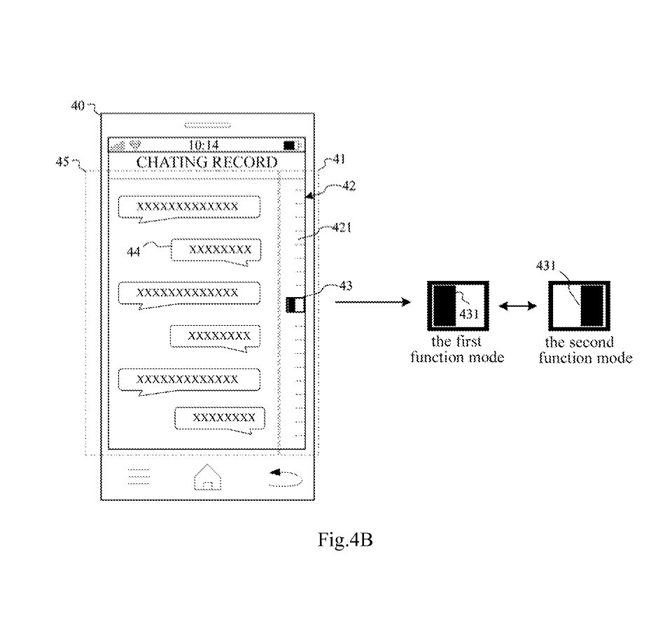

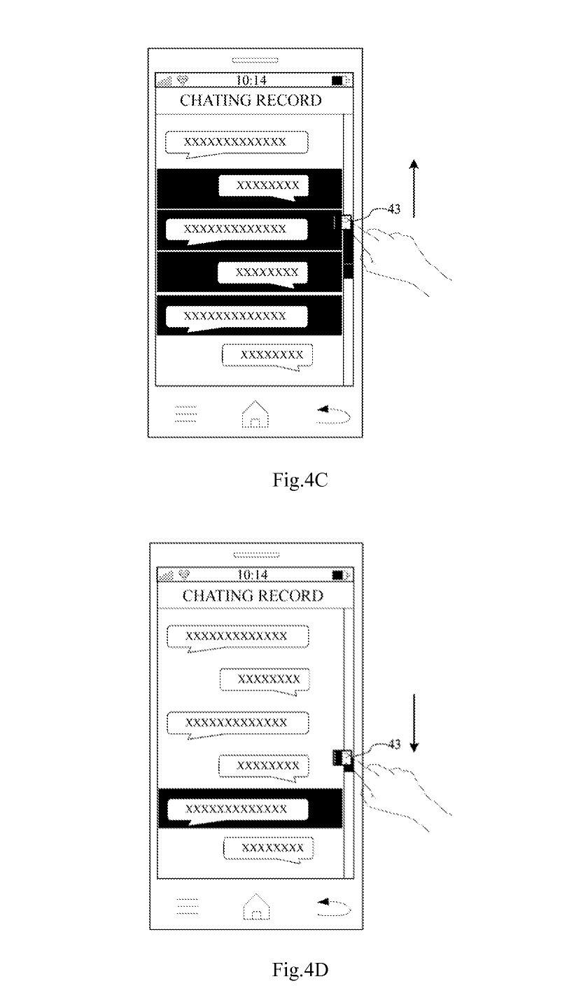

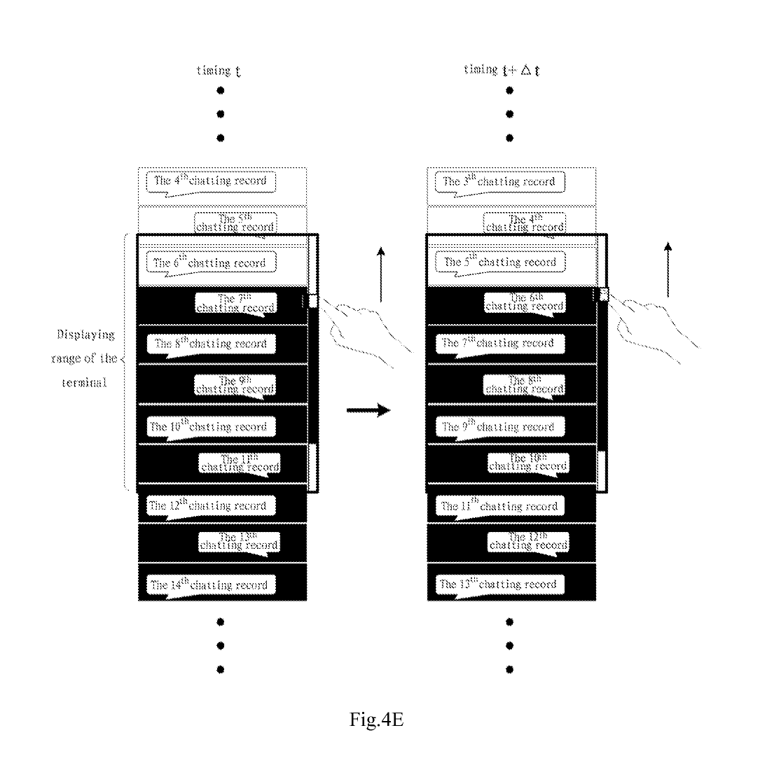

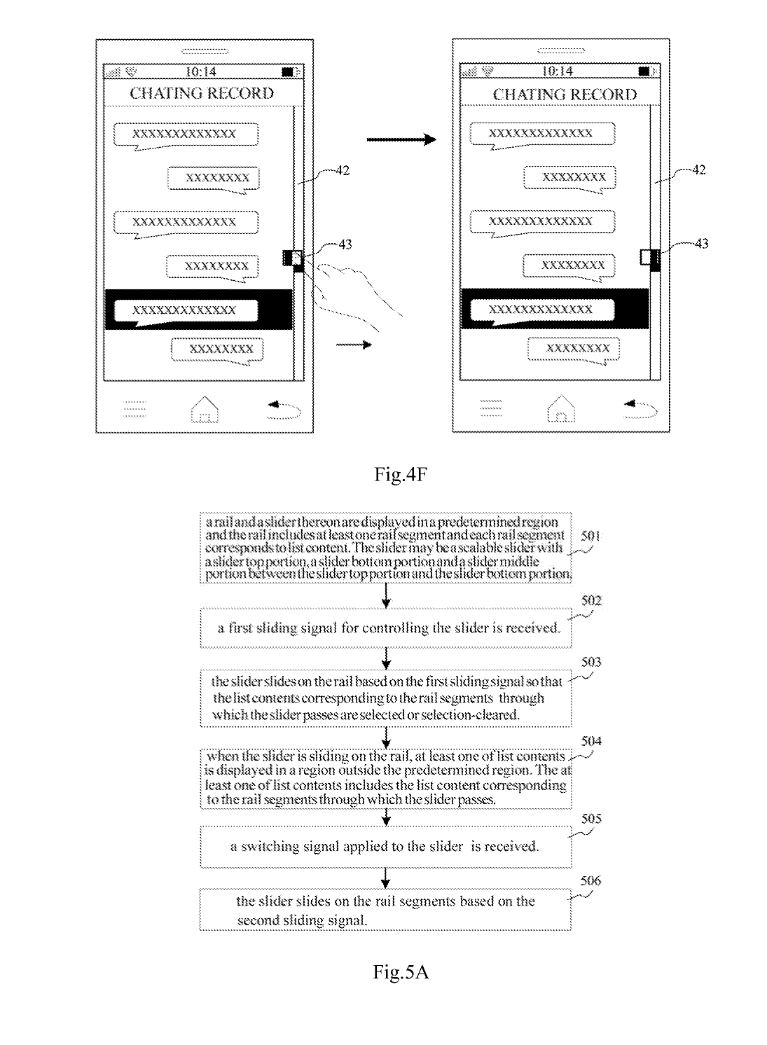

FIG. 4A is a flow chart of a method for selecting content according to a third embodiment of the present disclosure. FIGS. 4B-4F are operation schematic diagrams that show the procedures for selecting content according to the third embodiment of the present disclosure.

As shown in FIG. 4A, it is a flow chart of a method for selecting content according to a third embodiment of the present disclosure. The embodiment is illustrated by implementing the method for selecting content in a terminal. As a preferred embodiment, which is provided based on the first embodiment as shown in FIG. 2, the method includes the following steps.

At step S401, a rail and a slider on the rail are displayed in a predetermined region of a display screen of a terminal 40, and the rail includes at least one rail segment and each rail segment corresponds to one list content.

As shown in FIG. 4B, a terminal 40 has a user interface displayed on its screen. The user interface includes a predetermined region 41 and a rail 42 and a slider 43 on the rail displayed in the predetermined region 41. As shown, the predetermined region 41 is illustrated as the right region of the terminal 40.

The rail 42 includes at least one rail segment 421 and the number of the rail segments 421 is equal to the number of the list contents 44. For example, if the total number of the list contents 44 is 43, the number of the rail segments 421 is 43. A borderline (i.e. the transverse dot line as shown in the figure) between two adjacent rail segments 421 may or may not be displayed. The rail segments 421 correspond to the list contents 44 one by one, that is, in the order from the top to the bottom, the first rail segment 421 corresponds to the first list content 44, the second rail segment 421 corresponds to the second list content 44, and so on. In addition, since the length of the rail 42 is equal to that of the screen, the length of the rail segments 421 may be determined based on the total number n of the list contents 44. If the length of each of the rail segments 421 is the same, the length of each of the rail segments 421 is L/n.

A plurality of list contents 44 may be displayed in a left region 45 at the left of the predetermined region 41. The plurality of list contents displayed in the left region 45 may be all of the list contents or part of the list contents. The list content(s) after the currently displayed list contents can be viewed by scrolling up the left region 45, and the list content(s) before the currently displayed list contents can be viewed by scrolling down the left region 45. The scrolling operation in the left region 45 does not affect the display content in the predetermined region 41.

The height of the slider 43 may be equal to the length of one rail segment 421. The slider 43 may have two function modes, that is, the slider 43 may be switched between a first function mode and a second function mode. For an example, as shown in FIG. 4B, the slider 43 has a toggle button. If the toggle button is toggled to the left, the slider 43 is in the first function mode. If the toggle button is toggled to the right, the slider 43 is in the second function mode. FIG. 4B illustrates that the slider 43 is in the first function mode at this time.

At the step S402, the first sliding signal for controlling the slider is received. Specifically, when the slider 43 is in the first function mode, the terminal receives a dragging signal applied to the slider 43 and uses the dragging signal as the first sliding signal.

The dragging signal is a signal based on which the slider 43 is dragged up or down in a sliding direction of the rail.

At the step S403, the slider slides on the rail based on the first sliding signal so that the list contents corresponding to the rail segments through which the slider passes during its sliding are selected or selection-cleared. After receiving the first sliding signal, the terminal causes the slider 43 to slide on the rail based in the first sliding signal. When the slider 43 slides on the rail, it can pass through at least one rail segment 421.

Specifically, on the one hand, during the step 403, if the list content corresponding to the rail segments through which the slider passes is in an unchecked state, the unchecked state of the list content is switched into a checked state.

As shown in FIG. 4C, it is assumed that the initially all the list contents are in an unchecked state. At this time, the four list contents corresponding to the four rail segments through which the slider passes in sliding up may be selected, that is, the unchecked state of the four list contents is switched into the checked state.

On the other hand, if the list content corresponding to the rail segments through which the slider passes is in a checked state, the checked state of the list content is switched into an unchecked state.

As shown in FIG. 4D, it is assumed that the slider 43 is sliding down after the four list contents have been selected. The three list contents corresponding to the three rail segments through which the slider 43 passes in sliding down may be selection-cleared, that is, the checked state of the three list contents is switched into the unchecked state.

At the step S404, when the slider is sliding on the rail, at least one of the list contents is displayed in a region outside the predetermined region. The at least one of list content includes the list content corresponding to the rail segments through which the slider passes during its sliding.

In general, the sliding of the list contents displayed in the left region 45 is independent from that of the right slider 43. However, the sliding of the left region 45 and the right slider 43 can be associated with each other. In other words, when list contents corresponding to the rail segments through which the slider 43 is passing in its sliding are not in the left region 45, the list contents in the left region 45 may be displayed in scrolling so that at least one of the list contents displayed in the left region 45 includes the list content corresponding to the rail segments through which the slider passes during its sliding.

As shown in FIG. 4E, it is assumed that the slider is sliding up. At timing t, the list content “the seventh chat record” corresponding to the rail segments through which the slider is passing is the second of the list contents displayed in the left region. At timing t+.6t, the list content “the sixth chat record” corresponding to the rail segments through which the slider is passing is scrolled to the position in which the list content “the seventh chat record” was at timing t, and the list content “the fifth chat record” before the list content “the sixth chat record” is scrolled and displayed as the first list content. With this scrolling display, the list contents corresponding to the rail segments through which the slider is passing in its sliding can be displayed in the left region all the time. In the present embodiment, when the slider slides up, it is exemplified that the list content corresponding to the rail segments through which the slider is passing is the second list content. In other embodiments, the list contents corresponding to the rail segments through which the slider is passing may be the first list content, the middle list content, the second last list content, the last list content and so on, which is not limited in the description.

At the step S405, a switching signal applied to the slider 43 is received. There is a case that, in selecting list contents or clearing such selections, the position of the slider 43 needs to be adjusted probably. At this time, the slider 43 needs only to be moved on the rail 42 without performing the selection or selection-clearing on the list contents. For this reason, the terminal further receives a switching signal applied to the slider 43 and switches the slider 43 from the first function mode into the second function mode so that the terminal can subsequently receive a second sliding signal for controlling the slider 43.

As shown in FIG. 4F, the terminal may receive a right toggling signal applied to the slider 43 and take the right toggling signal as a switching signal.

At the step 406, the slider is switched from the first function mode into the second function mode based on the switching signal. Then, when the toggle button is toggled to the right, the slider 43 is in the second function mode.

According to an example of the present disclosure, in the following steps, the terminal may receive a left toggling signal applied to the slider 43 and take the left toggling signal as a switching signal, and then the slider 43 is switched from the second function mode into the first function mode based on the switching signal.

At the step S407, a second sliding signal for controlling the slider is received. When the slider 43 is in the second function mode, the terminal receives a dragging signal applied to the slider 43 and takes the dragging signal as the second sliding signal. The dragging signal may be a signal which causes the slider 43 to be dragged up or down in a sliding direction of the rail.

At the step S408, the slider slides on the rail segments based on the second sliding signal. After receiving the second sliding signal, the terminal causes the slider 43 to slide on the rail based on the second sliding signal. When the slider 43 slides on the rail, it may pass through the at least one rail segment but one or more list contents will not be selected or selection-cleared.

A user may perform any combination based on different sequences of the first sliding signal and the second sliding signal to freely determine to select one or more portions of all the list contents. Each portion of list contents may include one of the list contents or several adjacent successive list contents. If the user wants to select several successive list contents, the whole operation procedure includes only two steps “triggering the first sliding signal” and “dragging in the corresponding rail segments”.

By using the method for selecting content according to the present disclosure, when many list contents are selected at one time, the number of operations saved by the method of the present embodiment will be significant.

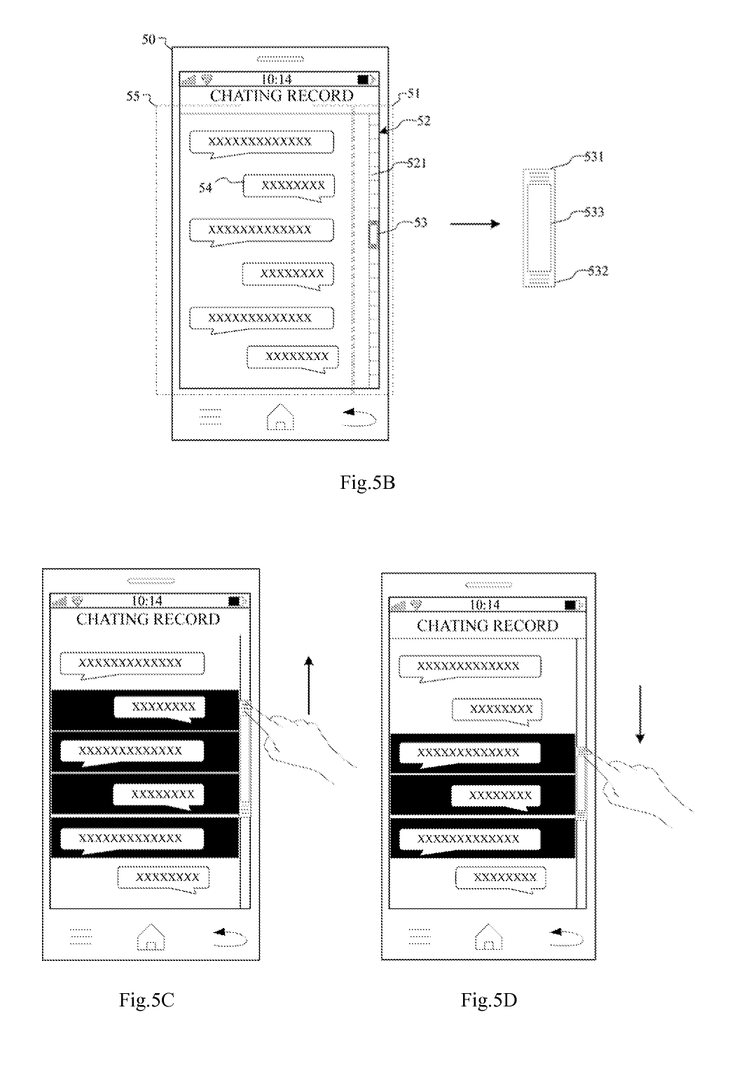

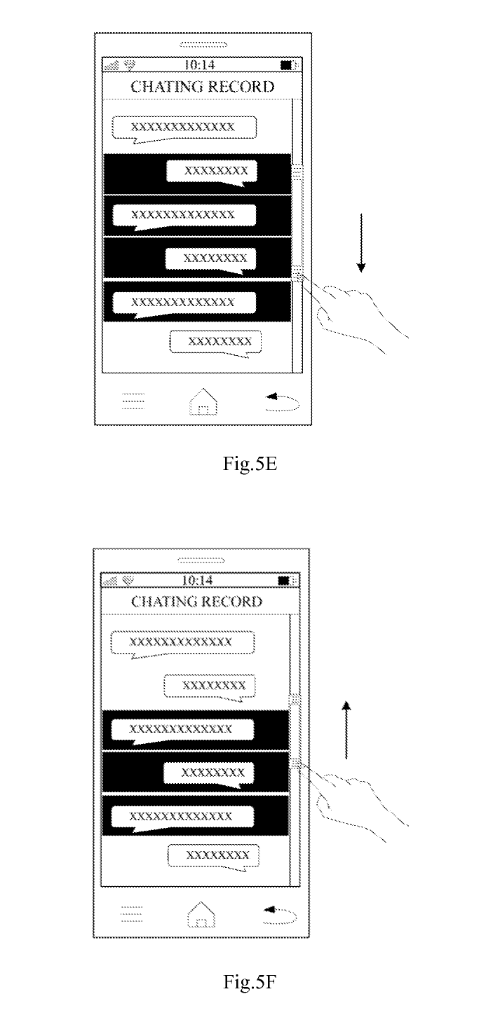

FIG. 5A is a flow chart of a method for selecting content according to a fourth embodiment of the present disclosure. FIGS. 5B-5G are operation schematic diagrams that show the procedures for selecting content according to the fourth embodiment of the present disclosure.

As shown in FIG. 5A, it is a flow chart of a method for selecting content according to a fourth embodiment of the present disclosure. The embodiment is illustrated by implementing the method for selecting content in a terminal. As a preferred embodiment that is provided based on the first embodiment as shown in FIG. 2, the method includes the following steps.

At step S501, a rail and a slider on the rail are displayed in a predetermined region of a display screen of a terminal 50, and the rail includes at least one rail segment and each rail segment corresponds to one list content. The slider may be a scalable slider including a slider top portion, a slider bottom portion and a slider middle portion between the slider top portion and the slider bottom portion.

As shown in FIG. 5B, a terminal 50 has a user interface displayed on its screen. The user interface includes a predetermined region 51 and a rail 52 and a slider 53 on the rail displayed in the predetermined region 51. As shown, the predetermined region 51 is illustrated as the right region of the terminal 50.

The rail 52 includes at least one rail segment 521 and the number of the rail segments 521 is equal to the number of the list contents 54. For example, if the total number of the list contents 54 is 108, the number of the rail segments 521 is 108. A borderline (i.e. the transverse dot line as shown in the figure) between two adjacent rail segments 521 may or may not be displayed. The rail segments 521 correspond to the list contents 54 one by one, that is, in the order from the top to the bottom, the first rail segment 521 corresponds to the first list content 54, the second rail segment 521 corresponds to the second list content 54, and so on. In addition, since the length of the rail 52 is equal to that of the screen, the length of the rail segments 52 may be determined based on the total number n of the list contents 54. If the length of each of the rail segments 521 is the same, the length of each of the rail segments 521 is L/n.

A plurality of list contents 54 may be displayed in a left region 55 at the left of the predetermined region 51. The plurality of list contents displayed in the left region 55 may be all of the list contents or part of the list contents. The list content(s) after the currently displayed list contents can be viewed by scrolling up the left region 55, and the list content(s) before the currently displayed list contents can be viewed by scrolling down the left region 55. The scrolling operation in the left region 55 does not affect the display content in the predetermined region 51.

The slider 3 may be a scalable slider including a slider top portion 531, a slider bottom portion 532 and a slider middle portion 533 between the slider top portion 531 and the slider bottom portion 533. The slider top portion 531 and the slider bottom portion 533 are configured to receive a first sliding signal and the slider middle portion 533 is configured to receive a second sliding signal.

At the step S502, a first sliding signal for controlling the slider is received. The terminal receives a dragging signal applied to the slider top portion 531 or the slider bottom portion 532 and takes the dragging signal as the first sliding signal.

The dragging signal is a signal based on which the slider top portion 531 is dragged up or down in a sliding direction of the rail. Alternatively, the dragging signal is a signal based on which the slider bottom portion 532 is dragged up or down in a sliding direction of the rail.

At the step S503, the slider slides on the rail based on the first sliding signal so that the list contents corresponding to the rail segments through which the slider passes during its sliding are selected or selection-cleared.

According to the description above, the terminal receiving the first sliding signal includes four cases as follows:

1) If the first sliding signal is a signal that drags the slider top portion 531 upwards in the sliding direction of the rail, that is, when the slider top portion 531 slides on the rail 52 in a direction away from the slider bottom portion 532, the position of the slider bottom portion 532 on the rail 52 is fixed and the middle portion 533 is elongated with the sliding of the slider top portion 531, as shown in FIG. 5C.

2) If the first sliding signal is a signal that drags the slider top portion 531 downwards in the sliding direction of the rail, that is, when the slider top portion 531 slides on the rail 52 in a direction approaching the slider bottom portion 532, the position of the slider bottom portion 532 on the rail 52 is fixed and the middle portion 533 is compressed with the sliding of the slider top portion 531, as shown in FIG. 5D.

3) If the first sliding signal is a signal that drags the slider bottom portion 532 downwards in the sliding direction of the rail, that is, when the slider bottom portion 532 slides on the rail 52 in a direction away from the slider top portion 531, the position of the slider top portion 531 on the rail 52 is fixed and the middle portion 533 is elongated with the sliding of the slider bottom portion 532, as shown in FIG. 5E.

4) If the first sliding signal is a signal that drags the slider bottom portion 532 upwards in the sliding direction of the rail, that is, when the slider bottom portion 532 slides on the rail 52 in a direction approaching the slider top portion 531, the position of the slider top portion 531 on the rail 52 is fixed and the middle portion 533 is compressed with the sliding of the slider bottom portion 532, as shown in FIG. 5F.

It should be noted that, in the present embodiment, the rail segments through which the slider top portion 531/the slider bottom portion 532 passes in its sliding are considered as the rail segments that the slider 53 passes through. When the slider top portion 531/the slider bottom portion 532 slides on the rail, at least one rail segment may be passed. At this time, on the one hand, if the list content corresponding to the rail segments through which the slider 53 passes is in an unchecked state, the unchecked state of the list content is switched into a checked state. On the other hand, if the list content corresponding to the rail segments through which the slider 53 passes is in a checked state, the checked state of the list content is switched into an unchecked state.

At the step S504, when the slider is sliding on the rail, at least one of the list contents is displayed in a region outside the predetermined region. The at least one of list content includes the list content corresponding to the rail segments through which the slider passes during its sliding.

In general, the sliding of the list contents displayed in the left region 55 is independent from that of the right slider 53. However, the sliding of the left region 55 and the right slider 53 can be associated with each other. In other words, when list contents corresponding to the rail segments through which the slider 53 is passing in its sliding are not in the left region 55, the list contents in the left region 55 may be displayed in scrolling so that at least one of the list contents displayed in the left region 55 includes the list content corresponding to the rail segments through which the slider passes during its sliding.

As shown in FIG. 5G, it is assumed that the slider bottom portion is sliding down. At timing t, the list content “the tenth chat record” corresponding to the rail segments through which the slider is passing is the second last one of the list contents displayed in the left region. At timing t+Δt, the list content “the eleventh chat record” corresponding to the rail segments through which the slider is passing is scrolled to the position in which the list content “the tenth chat record” was at timing t, and the list content “the twelfth chat record” after the list content “the eleventh chat record” is scrolled and displayed as the last list content. With this scrolling display, the list contents corresponding to the rail segments through which the slider is passing in its sliding can be displayed in the left region all the time. In the present embodiment, when the slider slides down, it is exemplified that the list content corresponding to the rail segments through which the slider is passing is the second last list content. In other embodiments, the list contents corresponding to the rail segments through which the slider is passing may be the first list content, the second list content, the middle list content, the last list content and so on, which is not limited in the description.

Correspondingly, the case that the slider top portion 531 slides upwards is similar to the case that the slider bottom portion 532 slides downwards. Therefore, the repeat description thereof is omitted.

At the step S505, a switching signal applied to the slider 53 is received. There is a case that, in selecting list contents or clearing such selections, the position of the slider 53 needs to be adjusted probably. At this time, the slider 53 needs only to be moved on the rail 52 without performing the selection or selection-clearing on the list contents. For this reason, the terminal receives a second sliding signal for controlling the slider 53. Specifically, the terminal receives a dragging signal applied to the slider middle portion 533 and takes the dragging signal as the second sliding signal. The dragging signal may be a signal, which causes the slider 53 to be dragged upwards or downwards in a sliding direction of the rail.

At the step S506, the slider slides on the rail segments based on the second sliding signal. After receiving the second sliding signal, the terminal causes the slider 53 to slide on the rail based on the second sliding signal. When the slider 53 slides on the rail, it may pass through the at least one rail segment but one or more list contents is not selected or selection-cleared.

A user may perform any combination based on different sequences of the first sliding signal and the second sliding signal to freely determine to select one or more portions of all the list contents. Each portion of list contents may include one of the list contents or several adjacent successive list contents. If the user wants to select several successive list contents, the whole operation procedure includes only two steps, “triggering the first sliding signal” and “dragging in the corresponding rail segments”.

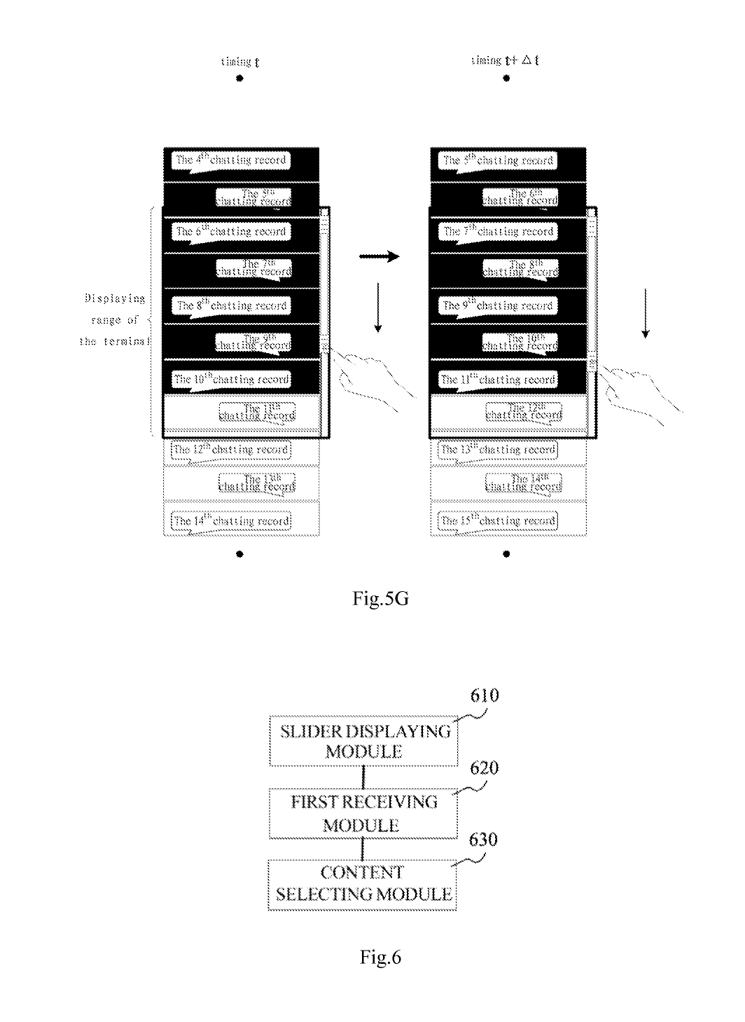

FIG. 6 is a structural block diagram that shows an apparatus for selecting content according to a fifth embodiment of the present disclosure.

As shown in FIG. 6, it is a structural block diagram that shows an apparatus for selecting content according to the fifth embodiment of the present disclosure. All or some of the embodiments of the apparatus for selecting content according to the present disclosure may be implemented by software, hardware or a combination thereof. The apparatus for selecting content comprises a slider displaying module 610, a first receiving module 620 and a content selecting module 630.

The slider displaying module 610 is configured to display a rail and a slider on the rail in a predetermined region of a display screen of a terminal, the rail including at least one rail segment and each rail segment corresponding to one of the list contents.

The first receiving module 620 is configured to receive a first sliding signal for controlling the slider.

The content selecting module 630 is configured to slide the slider on the rail based on the first sliding signal and perform selection operation or selection-clearing operation on the list content corresponding to the rail segments through which the slider passes during its sliding.

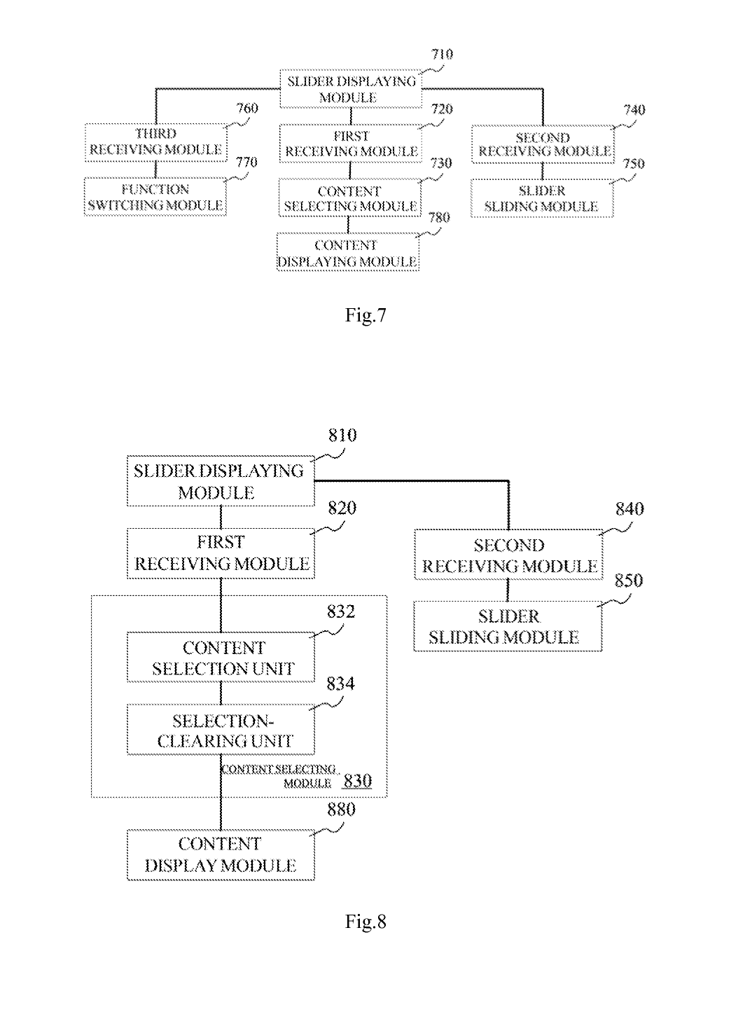

FIG. 7 is a structural block diagram that shows an apparatus for selecting content according to a sixth embodiment of the present disclosure.

As shown in FIG. 7, it is a structural block diagram that shows an apparatus for selecting content according to the sixth embodiment of the present disclosure. All or some of the embodiments of the apparatus for selecting content according to the present disclosure may be implemented by software, hardware or a combination thereof. The apparatus for selecting content includes a slider displaying module 710, a first receiving module 720, a content selecting module 730, a second receiving module 740 and a slider sliding module 750.

The slider displaying module 710 is configured to display a rail and a slider on the rail in a predetermined region, the rail including at least one rail segment and each rail segment corresponding to one of the list contents.

The first receiving module 720 is configured to receive a first sliding signal for controlling the slider.

The content selecting module 730 is configured to slide the slider on the rail based on the first sliding signal and perform selection operation or selection-clearing operation on the list content corresponding to the rail segments through which the slider passes during its sliding.

The second receiving module 740 is configured to receive a second sliding signal for controlling the slider.

The slider sliding module 750 is configured to slide the slider on the rail based on the second sliding signal.

In particular, the slider can be switched between a first function mode and a second function mode. The first receiving module 720 is configured to receive a dragging signal applied to the slider and take the dragging signal as the first sliding signal when the slider is in the first function mode. The second receiving module 740 is configured to receive a dragging signal applied to the slider and take the dragging signal as the second sliding signal when the slider is in the second function mode.

According to an example of the present embodiment, the apparatus for selecting content further includes a third receiving module 760 and a function switching module 770. The third receiving module 760 is configured to receive a switching signal applied to the slider. The function switching module 770 is configured to switch the slider from the first function mode into the second function mode based on the switching signal or switch the slider from the second function mode into the first function mode based on the switching signal.

According to an example of the present embodiment, the content selecting module 730 includes a content selection unit and a selection-clearing unit. The content selection unit is configured to switch an unchecked state of the list content into a checked state if the list content corresponding to the rail segments through which the slider passes is in the unchecked state. The selection-clearing unit is configured to switch a checked state of the list content into an unchecked state if the list content corresponding to the rail segments through which the slider passes is in the checked state.

According to an example of the present embodiment, the apparatus for selecting content further includes a content displaying module 780. The content displaying module 780 is configured to display at least one list content in a region outside the predetermined region when the slider is sliding on the rail, the at least one list content including the list content corresponding to the rail segments through which the slider passes during its sliding.

FIG. 8 is a structural block diagram that shows an apparatus for selecting content according to a seventh embodiment of the present disclosure.

As shown in FIG. 8, it is a structural block diagram that shows an apparatus for selecting content according to the seventh embodiment of the present disclosure. All or some of the embodiments of the apparatus for selecting content according to the present disclosure may be implemented by software, hardware or a combination thereof. The apparatus for selecting content includes a slider displaying module 810, a first receiving module 820, a content selecting module 830, a second receiving module 840 and a slider sliding module 850.

The slider displaying module 810 is configured to display a rail and a slider on the rail in a predetermined region of the display screen of a terminal, the rail including at least one rail segment and each rail segment corresponding to one of the list contents.

The first receiving module 820 is configured to receive a first sliding signal for controlling the slider.

The content selecting module 830 is configured to slide the slider on the rail based on the first sliding signal and perform selection operation or selection-clearing operation on the list content corresponding to the rail segments through which the slider passes during its sliding.

The second receiving module 840 is configured to receive a second sliding signal for controlling the slider.

The slider sliding module 850 is configured to slide the slider on the rail based on the second sliding signal.

In particular, the slider includes a first portion and a second portion. The first receiving module 820 is configured to receive a dragging signal applied to the first portion and use the dragging signal as the first sliding signal. The second receiving module 840 is configured to receive a dragging signal applied to the second portion and use the dragging signal as the second sliding signal.

According to an example of the present embodiment, the content selecting module 830 includes a content selection unit 832 and a selection-clearing unit 834. The content selection unit 832 is configured to switch an unchecked state of the list content into a checked state if the list content corresponding to the rail segments through which the slider passes is in the unchecked state. The selection-clearing unit 834 is configured to switch a checked state of the list content into an unchecked state if the list content corresponding to the rail segments through which the slider passes is in the checked state.

According to an example of the present embodiment, the apparatus for selecting content further includes a content displaying module 880. The content displaying module 880 is configured to display at least one list content in a region outside the predetermined region when the slider is sliding on the rail, the at least one list content including the list content corresponding to the rail segments through which the slider passes during its sliding.

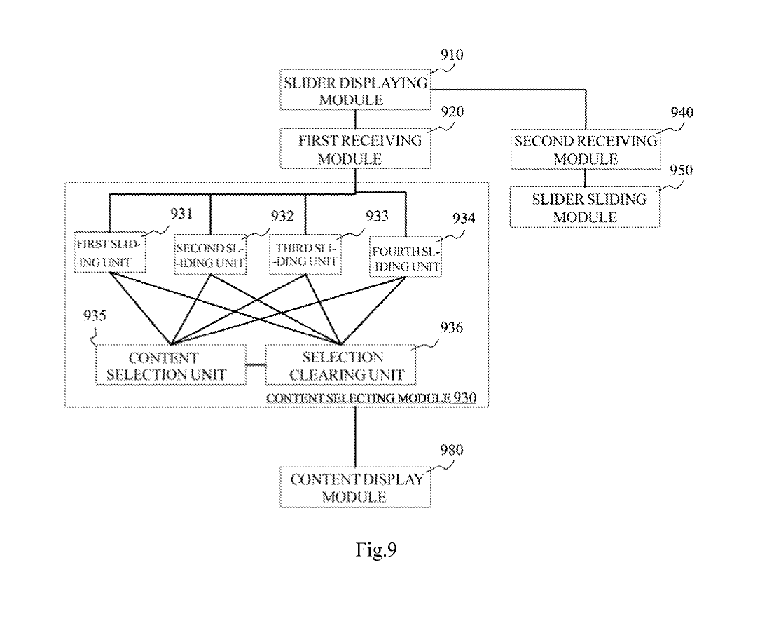

FIG. 9 is a structural block diagram that shows an apparatus for selecting content according to an eighth embodiment of the present disclosure.

As shown in FIG. 9, it is a structural block diagram that shows an apparatus for selecting content according to an eighth embodiment of the present disclosure. All or some of the embodiments of the apparatus for selecting content according to the present disclosure may be implemented by software, hardware or a combination thereof. The apparatus for selecting content includes a slider displaying module 910, a first receiving module 920, a content selecting module 930, a second receiving module 940 and a slider sliding module 950.

The slider displaying module 910 is configured to display a rail and a slider on the rail in a predetermined region of a display screen of a terminal, the rail including at least one rail segment and each rail segment corresponding to one of the list contents.

The first receiving module 920 is configured to receive a first sliding signal for controlling the slider.

The content selecting module 930 is configured to slide the slider on the rail based on the first sliding signal and perform selection operation or selection-clearing operation on the list content corresponding to the rail segments through which the slider passes during its sliding.

The second receiving module 940 is configured to receive a second sliding signal for controlling the slider.

The slider sliding module 950 is configured to slide the slider on the rail based on the second sliding signal.

In particular, the slider may be a scalable slider including a slider top portion, a slider bottom portion and a slider middle portion between the slider top portion and the slider bottom portion. The first receiving module 920 is configured to receive a dragging signal applied to the slider top portion or the slider bottom portion and take the dragging signal as the first sliding signal. The second receiving module 940 is configured to receive a dragging signal applied to the slider middle portion and take the dragging signal as the second sliding signal.

According to an example of the present embodiment, the content selecting module 930 includes a first sliding unit 931 and a second sliding unit 932. The first sliding unit 931 is configured to fix the position of the slider bottom portion on the rail and elongate the middle portion of the slider with the sliding of the slider top portion while the slider top portion slides on the rail in the direction away from the slider bottom portion. The second sliding unit 932 is configured to fix the position of the slider bottom portion on the rail and shorten the middle portion of the slider with the sliding of the slider top portion while the slider top portion slides on the rail in the direction approaching the slider bottom portion.

According to an example of the present embodiment, the content selecting module includes a third sliding unit 933 and a fourth sliding unit 934. The third sliding unit 933 is configured to fix the position of the slider top portion on the rail and elongate the middle portion of the slider with the sliding of the slider bottom portion while the slider bottom portion slides on the rail in the direction away from the slider top portion. The fourth sliding unit 934 is configured to fix the position of the slider top portion on the rail and shorten the middle portion of the slider with the sliding of the slider bottom portion while the slider bottom portion slides on the rail in the direction approaching the slider top portion.

According to an example of the present embodiment, the content selecting module 930 includes a content selection unit 935 and a selection-clearing unit 936. The content selection unit 935 is configured to switch an unchecked state of the list content into a checked state if the list content corresponding to the rail segments through which the slider passes is in the unchecked state. The selection-clearing unit 936 is configured to switch a checked state of the list content into an unchecked state if the list content corresponding to the rail segments through which the slider passes is in the checked state.

According to an example of the present embodiment, the apparatus for selecting content further includes a content displaying module 980. The content displaying module 980 is configured to display at least one list content in a region outside the predetermined region when the slider is sliding on the rail, the at least one list content including the list content corresponding to the rail segments through which the slider passes during its sliding.

It should be noted that the apparatuses for selecting content according to the embodiments described above are exemplified by being divided into the respective function modules mentioned above. However, in actual implementation, the functions mentioned above can be achieved by a different function module. That is, the configuration of the apparatus can be divided into different function modules to implement all or some of the functions mentioned above. In addition, the apparatus and the method for selecting content according to the embodiments belong to the same concept. Therefore, the specific implementing procedure of the apparatus may refer to those of the method embodiments. The description thereof is omitted herein.

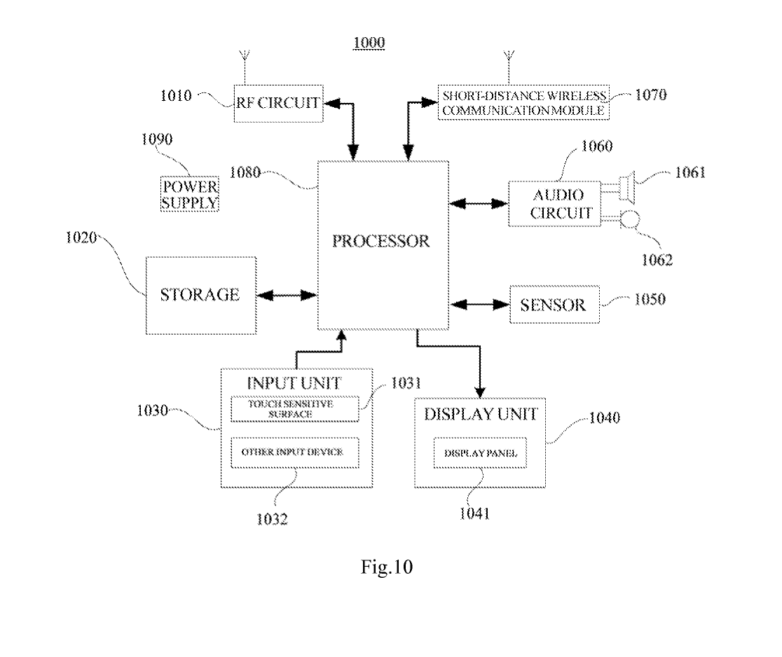

FIG. 10 is a structural schematic diagram that shows a terminal according to a ninth embodiment of the present disclosure.

As shown in FIG. 10, it is a structural schematic diagram that shows an electronic device according to a ninth embodiment of the present disclosure. The electronic device is used to implement the content selecting method according to the embodiments described above.

As an embodiment, the electronic device 1000 may includes an RF circuit 1010, a storage 1020 including one or more computer-readable memory media, an input unit 1030, a display unit 1040, a sensor 1050, an audio circuit 1060, a short-distance wireless communication module 1070, a processor 1080 including one or more processing cores, and a power supply 1090 and so on. A person skilled in the art may conceive that the configuration of the electronic device as illustrated in FIG. 10 is not a limit and the electronic device may include more or fewer components, combine some components, or arrange the components in a different way.

Specifically, the RF circuit 1010 may be configured to transmit or receive a signal in transmitting or receiving messages or calling. In particular, after receiving downstream information from a base station, the RF circuit 1010 submits it to one or more processors 1080 to process it. On the other hand, the RF circuit 1010 transmits upstream data to the base station. In general, the RF circuit 1010 includes, but not limited to, an antenna, at least one amplifier, a tuner, one or more oscillators, SIM card, transceiver, a coupler, a low noise amplifier (LNA), and diplexer and so on. In addition, the RF circuit 1010 may further communicate with other devices by a wireless communication and network. The wireless communication may adopt any communication standard or protocol including, but not limited to, Global System of Mobile communication (GSM), General Packet Radio Service (GPRS), Code Division Multiple Access (CDMA), Wideband Code Division Multiple Access (WCDMA), Long Term Evolution (LTE), email, Short Messaging Service (SMS) and so on.

The storage 1020 may be used to store a software program and a module. The processor 1080 may execute a variety of functional applications and process data by running the software program and module stored in the storage 1020. The storage 1020 mainly includes a program storage area and a data storage area. The program storage area may store an operation system and an application program required by at least a function such as an audio playing function, video playing function or the like. The data storage area may store the data such as audio data or phone book, which are created by using the electronic device 1000. Further, the storage 1020 may be a RAM, a non-transitory memory such as a magnetic disk storage device, a flash memory or other non-volatile memory. Correspondingly, the storage 1020 may include a memory controller, which provides the processor 1080 and the input unit 1030 with access to the storage 1020.

The input unit 1030 may be used to receive digital or character information to be inputted and produce an information input associated with a user setting and a function control by a keyboard, a mouse, a joy stick, optical or track ball. Specifically, the input unit 1030 may include a touch sensitive surface 1031 and other input device 1032. The touch sensitive surface 1031, also referred to as a touch screen or a touch control panel, may collect touch operations of the user applied to the screen or near the screen, such as the operations on or near the touch sensitive surface 1031 applied by the user using any suitable subject or attachments including a finger and a touch pen, and drive a corresponding linked device based on a preset program. Alternatively, the touch sensitive surface 1031 may include two portions of a touch detection device and a touch controller. The touch detection device is configured to detect a touch orientation of the user and a signal generated by the touch operation and to transmit the detected signal to the touch controller. The touch controller receives the touch signal from the touch detection device, transfers the received signal into the coordinate of the touch point and then transmits the transferred coordinate to the processor 1080, and receives and executes an instruction from the processor 1080. In addition, the touch sensitive surface 1031 can be implemented in a variety of types such as resistance-type, capacitance-type, infrared-type, or surface acoustic wave type and so on. Besides the touch sensitive surface 1031, the input unit 1030 further includes another input device 1032. Specifically, the other input device 1032 may include but is not limited to one or more of a physical keyboard, a function keyboard such as a sound volume control push-key and a switch push-key or the like, a trick ball, a mouse and a joystick and so on.

The display unit 1040 may be used to show information inputted by or outputted to the user and a variety of graphical user interfaces (GUI) of the electronic device 1000. The GUI may be configured by graph, text, icon, video and any combination thereof. The display unit 1040 may include a display panel 1041. Optionally, the display panel 1041 can be configured in a form of a Liquid Crystal Display (LCD), or an Organic Light-Emitting Diode (OLED). Further, the touch sensitive surface 1031 overlays on the display panel 1041. After the touch sensitive surface 1031 detects a touch operation on or near the surface, the detected touch operation is transmitted to the processor 1080 to determine the type of the touch event. Subsequently, the processor 1080 provides a vision output in the display panel 1041 based on the type of the touch event. Although, in FIG. 10, the touch sensitive surface 1031 and the display panel 1041 are implemented in two independent components, they may be integrated with each other in other embodiments to achieve an input-output function.

The electronic device 1000 further includes at least one sensor 1050 such as an optical sensor, a motion sensors and other sensor. Specifically, the optical sensor may include an ambient light sensor and a proximity sensor. The ambient light sensor may adjust the brightness of the display panel 1041 based on the strength of the ambient light. The proximity sensor may turn off the display panel 1041 and/or the backlight when the electronic device 1000 approaches the ear. As a type of motion sensor, a gravitation sensor (G-sensor) can detect the acceleration of each direction (in general, three axis directions) and detect the gravity and its direction. The detection result of the sensor may be applied to an application for identifying the posture of a cell phone, such as an application of a panel switch between a transverse direction and a longitudinal direction mutually, an associated games and a magnetometer posture calibration, and to an associated function for identifying a vibration, such as a function of a step counter or a tap counter. As for the electronic device 1000, it may be provided with another sensor such as gyroscope, barometer, hygrometer, thermometer, infrared sensor and so on, the description that relates to them is omitted.

The audio circuit 1060, a speaker 1061 and a microphone 1062 may provide an interface between the user and the electronic device 1000. The audio circuit 1060 can transmit the electric signal converted from received audio data to the speaker 1061 to convert the electric signal into a sound signal and then output it. On the other hand, the microphone 1062 collects sound signals and convert them into electric signals. The audio circuit 1060 receives the electric signal, converts the received electric signal into audio data, and then transmits the audio data to the processor 1080. After being processed by the processor 1080, the audio data is transmitted to another terminal or outputted to the storage 1020 to be processed in future. The audio circuit 1060 further includes an earphone socket for communication between an external earphone and the electronic device 1000.

The short-distance wireless communication module 1070 may be a wireless fidelity (WiFi) module, a blue-tooth module or the like. The electronic device 1000 may help the user receive or send email, view webpages and access streaming media by means of the short-distance wireless communication module 1070. Further, the electronic device 1000 may provide the user with wireless broadband internet access by means of the short-distance wireless communication module 1070. Although the short-distance wireless communication module 1070 is illustrated in FIG. 10, it shall be understood that the short-distance wireless communication module 1070 is not a necessary component of the electronic device 1000 and can be omitted without departing from the substantial scope of the present disclosure if needed.

The processor 1080 is the control center of the electronic device 1000, uses a variety of interfaces and wiring to connect all the components of the electronic device, invokes the data stored in the storage 1020 by running or executing the software program and/or module stored in the storage 1020 so as to perform the variety of functions of the electronic device 1000 and process the data, and monitors wholly the electronic device. Alternatively, the processor 1080 may include one or more processing cores. Preferably, the processor 1080 may integrate an application processor and a modem. The application processor mainly processes the operation system, the user interface, the application program and so on. The modem mainly processes wireless communication. It shall be understood that the modem may not be integrated into the processor 1080.

The electronic device 1000 further includes a power supply 1090, such as a battery, which powers all the components. Preferably, the power supply may logically connect to the processor 1080 through a power supply management system so as to achieve the functions of charging, discharging and power consumption management by the power supply management system. The power supply 1090 further includes one or more DC or AC power supplies, rechargeable system, power supply fault detection circuit, power supply convertor or inverter, power supply state indicator and any combination thereof.

Although not shown, the electronic device 1000 may include a camera, blue-tooth module and so on, whose description is omitted herein. In a specific embodiment, the display unit of the electronic device 100 may be a touch panel display.

The electronic device 1000 further includes storage and one or more programs. The one or more programs are stored in the storage and configured to be executed by one or more processors. The instructions contained in the one or more programs are used to execute a method for selecting content. The method for selecting content is the one as shown in FIG. 2 and the embodiments corresponding to FIG. 2, and/or the one as shown in FIG. 3A and the embodiments corresponding to FIG. 3A, and/or the one as shown in FIG. 4A and the embodiments corresponding to FIG. 4A, and/or the one as shown in FIG. 5A and the embodiments corresponding to FIG. 5A.

As another aspect, a further embodiment of the present disclosure provides a computer-readable memory medium, which may be a computer-readable memory medium contained in the storage of the above embodiments, or a single one, which is not installed in the electronic device or a server. The computer-readable memory medium has one or more programs. The one or more programs are executed by one or more processors to execute a method for selecting content. The method for selecting content is the one as shown in FIG. 2 and the embodiments corresponding to FIG. 2, and/or the one as shown in FIG. 3A and the embodiments corresponding to FIG. 3A, and/or the one as shown in FIG. 4A and the embodiments corresponding to FIG. 4A, and/or the one as shown in FIG. 5A and the embodiments corresponding to FIG. 5A.

As yet another aspect, another embodiment of the present disclosure provides a graphical user interface (GUI). The GUI is used in a terminal. The terminal includes a touch panel display, a memory and one or more processors for executing one or more programs. The GUI is configured to display a rail and a slider on the rail in a predetermined region, the rail including at least one rail segment and each rail segment corresponding to one list content; to receive a first sliding signal for controlling the slider; and to slide the slider on the rail based on the first sliding signal and perform selection operation or selection-clearing operation on the list content corresponding to the rail segments through which the slider passes during its sliding.

According to an embodiment of the present disclosure, the GUI is further configured to receive a second sliding signal for controlling the slider and slide the slider on the rail based on the second sliding signal.

According to an embodiment of the present disclosure, the slider can be switched between a first function mode and a second function mode. Receiving the first sliding signal for controlling the slider includes receiving a dragging signal applied to the slider and using the dragging signal as the first sliding signal when the slider is in the first function mode, and receiving the second sliding signal for controlling the slider includes receiving a dragging signal applied to the slider and using the dragging signal as the second sliding signal when the slider is in the second function mode.

According to an embodiment of the present disclosure, the GUI is further configured to, before receiving the dragging signal applied to the slider, receive a switching signal applied to the slider and switch the slider from the first function mode into the second function mode based on the switching signal or switch the slider from the second function mode into the first function mode based on the switching signal.

According to an embodiment of the present disclosure, the slider includes a first portion and a second portion. Receiving the first sliding signal for controlling the slider includes receiving a dragging signal applied to the first portion and using the dragging signal as the first sliding signal, and receiving the second sliding signal for controlling the slider includes receiving a dragging signal applied to the second portion and using the dragging signal as the second sliding signal.

According to an embodiment of the present disclosure, the slider may be a scalable slider including a slider top portion, a slider bottom portion and a slider middle portion. Receiving the first sliding signal for controlling the slider includes receiving a dragging signal applied to the slider top portion or the slider bottom portion and using the dragging signal as the first sliding signal, and receiving the second sliding signal for controlling the slider includes receiving a dragging signal applied to the slider middle portion and using the dragging signal as the second sliding signal.

According to an embodiment of the present disclosure, sliding the slider on the rail based on the first sliding signal includes the position of the slider bottom portion on the rail is fixed and the middle portion of the slider is elongated with the sliding of the slider top portion while the slider top portion slides on the rail in the direction away from the slider bottom portion; and the position of the slider bottom portion on the rail is fixed and the middle portion of the slider is shortened with the sliding of the slider top portion while the slider top portion slides on the rail in the direction approaching the slider bottom portion.

According to an embodiment of the present disclosure, sliding the slider on the rail based on the first sliding signal includes the position of the slider top portion on the rail is fixed and the middle portion of the slider is elongated with the sliding of the slider bottom portion while the slider bottom portion slides on the rail in the direction away from the slider top portion; and the position of the slider top portion on the rail is fixed and the middle portion of the slider is shortened with the sliding of the slider bottom portion while the slider bottom portion slides on the rail in the direction approaching the slider top portion.

According to an embodiment of the present disclosure, performing selection operation or selection-clearing operation on the list content corresponding to the rail segments through which the slider passes during its sliding includes switching an unchecked state of the list content into a checked state if the list content corresponding to the rail segments through which the slider passes is in the unchecked state, and switching a checked state of the list content into an unchecked state if the list content corresponding to the rail segments through which the slider passes is in the checked state.

According to an embodiment of the present disclosure, the GUI is further configured to display at least one list content in a region outside the predetermined region when the slider is sliding on the rail, the at least one list content including the list content corresponding to the rail segments through which the slider passes during its sliding.

It shall be understood that, although the terms “the first” and “the second” are used to describe some elements or embodiments, these elements shall not be limited by such terms and these embodiments shall not be construed that one embodiment is better than another. It shall be further understood that the singular forms “a”, “an” and “the” are intended to include the plural forms as well, unless the context clearly indicates otherwise. It will be further understood that the phrase “and/or” used herein specifies any or all probable combinations of one or more items listed in relation thereto.

The numbers of the above embodiments are only for description, and do not indicate whether the embodiments are good or not.

A person skilled in the art can understand that the entire processes or part thereof described above may be implemented by hardware or by a computer program running on relevant hardware. Said program may be stored in a computer-readable storage medium, which may include a read-only memory (ROM), a magnetic disk, or a CD (compact disc) etc.

The descriptions of the various embodiments of the present invention have been presented only for purposes of illustration, but are not intended to be exhaustive or limited to the embodiments disclosed. Many modifications and variations will be apparent to those of ordinary skill in the art without departing from the scope and spirit of the described embodiments.

What is claimed is:

1. A method for selecting content, comprising:
displaying, by a slider displaying module using a processor, a rail and a slider on the rail in a predetermined region of a display screen, the rail comprising at least one rail segment and each of the at least one rail segments corresponding to one list content;
receiving, by a first receiving module using a processor, a first sliding signal for controlling the slider; and
sliding, by a content selecting module using a processor, the slider on the rail based on the first sliding signal and performing selection operation or selection-clearing operation on the list content corresponding to the at least one rail segments through which the slider passes during sliding.

2. The method of claim 1, further comprising:
receiving, by a second receiving module using a processor, a second sliding signal for controlling the slider; and
sliding, by the slider sliding module using a processor, the slider on the rail based on the second sliding signal.

3. The method of claim 2, wherein the slider is switched between a first function mode and a second function mode, the receiving the first sliding signal for controlling the slider comprises receiving a dragging signal applied to the slider and using the dragging signal as the first sliding signal when the slider is in the first function mode, and the receiving the second sliding signal for controlling the slider comprises receiving a dragging signal applied to the slider and using the dragging signal as the second sliding signal when the slider is in the second function mode.

4. The method of claim 3, comprising: prior to receiving the dragging signal applied to the slider,
receiving, by a third receiving module using a processor, a switching signal applied to the slider; and
switching, by a function switching module using a processor, the slider from the first function mode into the second function mode based on the switching signal or switching the slider from the second function mode into the first function mode based on the switching signal.

5. The method of claim 2, wherein the slider comprises a first portion and a second portion, the receiving the first sliding signal for controlling the slider comprises receiving a dragging signal applied to the first portion and using the dragging signal as the first sliding signal, and the receiving the second sliding signal for controlling the slider comprises receiving a dragging signal applied to the second portion and using the dragging signal as the second sliding signal.

6. The method of claim 2, wherein the slider is a scalable slider comprising a slider top portion, a slider bottom portion and a slider middle portion, the receiving the first sliding signal for controlling the slider comprises receiving a dragging signal applied to the slider top portion or the slider bottom portion and using the dragging signal as the first sliding signal, and the receiving the second sliding signal for controlling the slider comprises receiving a dragging signal applied to the slider middle portion and using the dragging signal as the second sliding signal.

7. The method of claim 6, wherein the sliding the slider on the rail based on the first sliding signal comprises:
the position of the slider bottom portion on the rail is fixed and the middle portion of the slider is elongated with the sliding of the slider top portion while the slider top portion slides on the rail in the direction of being away from the slider bottom portion; and
the position of the slider bottom portion on the rail is fixed and the middle portion of the slider is shortened with the sliding of the slider top portion while the slider top portion slides on the rail in the direction of approaching to the slider bottom portion.

8. The method of claim 6, wherein the sliding the slider on the rail based on the first sliding signal comprises:
the position of the slider top portion on the rail is fixed and the middle portion of the slider is elongated with the sliding of the slider bottom portion while the slider bottom portion slides on the rail in the direction of being away from the slider top portion; and
the position of the slider top portion on the rail is fixed and the middle portion of the slider is shortened with the sliding of the slider bottom portion while the slider bottom portion slides on the rail in the direction of approaching to the slider top portion.

9. The method of claim 1, wherein the performing selection operation or selection-clearing operation on the list content corresponding to the at least one rail segment through which the slider passes during its sliding comprises:
switching an unchecked state of the list content into a checked state if the list content corresponding to the at least one rail segment through which the slider passes is in the unchecked state, and
switching a checked state of the list content into an unchecked state if the list content corresponding to the at least one rail segment through which the slider passes is in the checked state.

10. The method of claim 1, further comprising displaying, by a content displaying module using a processor, at least one list content in a region outside the predetermined region when the slider is sliding on the rail, the at least one list content comprising the list content corresponding to the at least one rail segment through which the slider passes during its sliding.

11. An apparatus for selecting content, comprising:
a slider displaying module using a processor and configured to display a rail and a slider on the rail in a predetermined region of a display screen, the rail including at least one rail segment and each of the at least one rail segment corresponding to one list content;
a first receiving module using a processor and configured to receive a first sliding signal for controlling the slider; and
a content selecting module using a processor and configured to slide the slider on the rail based on the first sliding signal and perform selection operation or selection-clearing operation on the list content corresponding to the at least one rail segment through which the slider passes during sliding.

12. The apparatus of claim 11, further comprising:
a second receiving module using a processor and configured to receive a second sliding signal for controlling the slider; and
a slider sliding module using a processor and configured to slide the slider on the rail based on the second sliding signal.

13. The apparatus of claim 12, wherein the slider is switched between a first function mode and a second function mode, the first receiving module is configured to receive a dragging signal applied to the slider and use the dragging signal as the first sliding signal when the slider is in the first function mode, and the second receiving module is configured to receive a dragging signal applied to the slider and use the dragging signal as the second sliding signal when the slider is in the second function mode.

14. The apparatus of claim 13, further comprising:
a third receiving module using a processor and configured to receive a switching signal applied to the slider; and
a function switching module using a processor and configured to switch the slider from the first function mode into the second function mode based on the switching signal or switch the slider from the second function mode into the first function mode based on the switching signal.

15. The apparatus of claim 12, wherein the slider comprises a first portion and a second portion, the first receiving module is configured to receive a dragging signal applied to the first portion and use the dragging signal as the first sliding signal, and the second receiving module is configured to receive a dragging signal applied to the second portion and use the dragging signal as the second sliding signal.

16. The apparatus of claim 12, wherein the slider may be a scalable slider comprising a slider top portion, a slider bottom portion and a slider middle portion, the first receiving module is configured to receive a dragging signal applied to the slider top portion or the slider bottom portion and use the dragging signal as the first sliding signal, and the second receiving module is configured to receive a dragging signal applied to the slider middle portion and use the dragging signal as the second sliding signal.

17. The apparatus of claim 16, wherein the content selecting module comprises:
a first sliding unit configured to fix the position of the slider bottom portion on the rail and elongate the middle portion of the slider with the sliding of the slider top portion while the slider top portion slides on the rail in the direction of being away from the slider bottom portion; and
a second sliding unit configured to fix the position of the slider bottom portion on the rail and shorten the middle portion of the slider with the sliding of the slider top portion while the slider top portion slides on the rail in the direction of approaching to the slider bottom portion.

18. The apparatus of claim 16, wherein the content selecting module comprises:
a third sliding unit configured to fix the position of the slider top portion on the rail and elongate the middle portion of the slider with the sliding of the slider bottom portion while the slider bottom portion slides on the rail in the direction of being away from the slider top portion; and
a fourth sliding unit configured to fix the position of the slider top portion on the rail and shorten the middle portion of the slider with the sliding of the slider bottom portion while the slider bottom portion slides on the rail in the direction of approaching to the slider top portion.

19. The apparatus of claim 11, wherein the content selecting module comprises:
a content selection unit configured to switch an unchecked state of the list content into a checked state if the list content corresponding to the at least one rail segment through which the slider passes is in the unchecked state, and
a selection-clearing unit configured to switch a checked state of the list content into an unchecked state if the list content corresponding to the at least one rail segment through which the slider passes is in the checked state.

20. The apparatus of claim 11, further comprising a content displaying module using a processor and configured to display at least one list content in a region outside the predetermined region when the slider is sliding on the rail, the at least one list content comprising the list content corresponding to the at least one rail segment through which the slider passes during its sliding.
